(19) United States
(12) Patent Application Publication
(10) Pub. No.: US 2019/0117357 A1
(43) Pub. Date: Apr. 25, 2019

(54) AN INTEGRATED FLUID CONNECTION/DRIVE TRAIN INTERFACE FOR AN ORAL HEALTHCARE APPLIANCE AND METHOD

(71) Applicant: KONINKLIJKE PHILIPS N.V., EINDHOVEN (NL)

(72) Inventors: JOLDERT MARIA BOERSMA, GRONINGEN (NL); STEPHANUS JACOB GERARDUS TAMMINGA, GRONINGEN (NL); KLAAS KOOIJKER, DRACHTEN (NL)

(21) Appl. No.: 16/094,339

(22) PCT Filed: Apr. 10, 2017
(86) PCT No.: PCT/EP2017/058478

§ 371 Date: Oct. 17, 2018

Related U.S. Application Data
(60) Provisional application No. 62/326,212, filed on Apr. 22, 2016.

(51) Int. Cl. A61C 17/36; A61C 17/22; A61C 17/34

(52) U.S. Cl. CPC A61C 17/36; A61C 17/3418; A61C 17/227

(57) ABSTRACT

An integrated fluid connection/drive train interface (12) for an oral healthcare appliance (10) having a fluid connection interface (22) mechanically coupled with the drive shaft (28) and further configured to couple to a removable brushhead (30). The fluid connection interface includes a fluid inlet coupling (42) coupled, via a fluid channel (24), to the fluid reservoir, and a fluid outlet coupling (44). Responsive to the brushhead being removably coupled, the fluid outlet coupling of the fluid connection interface establishes a water/air tight sealing arrangement with a fluid interface receiver port (36) of the brushhead. In addition, the drive shaft is configured for driving the brushhead and the fluid connection interface while maintaining the water/air tight seal between the fluid outlet coupling and the fluid interface receiver port of the brushhead.

The present embodiments relate generally to oral healthcare and more particularly, to an integrated fluid connection drive train interface for an oral healthcare appliance and a method thereof.

With respect to oral healthcare, it is well known that tooth brushing alone is generally not sufficient for proper dental care. Classically, toothpicks and flossing wire are used to clean interdental spaces, between teeth. However, these methods are often considered unpleasant or requiring high dexterity to reach all interdental spaces.

As an alternative, water and water/air based appliances have been developed to fulfill the task of cleaning interdental spaces by shots or sprays of water or other liquid. Examples of such water and water/air based appliances include the Philips® Airfloss™ However, these are individual appliances which have to be used along with and/or next to a regular or power toothbrush. Some devices are known that integrate a water jet into a tooth brush. However, the water connection for the brush heads is placed far away (at a distal end) from the driving mechanical actuation connection and tubing renders the brush head very large and bulky, when compared to a brush with bristles alone. Furthermore, a disadvantage of such a configuration includes large friction losses due to stiff hoses. Such losses could be unacceptable in a low-power, battery operated device.

Accordingly, an improved method and apparatus for overcoming the problems in the art is desired.

In accordance with one aspect, an integrated fluid connection/drive train interface device is disclosed that advantageously provides a hydrodynamic connection between a handle containing an actuator and a pump and a brush head that requires a supply of liquid and/or air from that handle and at the same time is being driven (i.e., oscillated) about an axis that connects the brush head with the handle. The pump located within the handle provides liquid to the brushhead for cleaning teeth in the oral cavity by hydrodynamic forces, the hydrodynamic forces being proximate or next to the mechanical cleaning forces applied by bristles. In particular, the liquid can reach places where the bristles alone cannot clean (e.g., interdental spaces, gingival cavities, and near the gumline). To this end, high pressures and small nozzle diameters are used to get sufficient cleaning, while limiting the amount of water needed.

In accordance with another aspect, the hydrodynamic connection can also be used to receive feedback from the brushhead and an in-situ cleaning performance. For example, pressure pulsations, such as air or other suitable gas, will reflect differently from a tooth surface depending on the condition of the surface (i.e., clean or covered with plaque) as well as depending on the position of the brushhead versus a tooth under test (e.g., frontal, interdental, etc.). In addition to liquid transport, this feedback receiving application can advantageously utilize the fluid connection between the brushhead and toothbrush body.

In accordance with another aspect, an integrated fluid connection/drive train interface provides a hydrodynamic connection between a brushhead and an appliance handle (i.e., with an drive motor or actuator), the connection being made without affecting the mechanical movement of the brushhead, which at the same time, guarantees a good watertight sealing between brushhead and handle. In addition, an oral healthcare appliance is provided which includes a water spray feature to a power toothbrush itself, and integration requires water, or another liquid, to be transported from the body of the toothbrush to the detachable brushhead. The integrated fluid connection/drive train interface device as disclosed herein advantageously allows such water, or other liquid, transport while keeping the power toothbrush function.

In accordance yet another aspect, an integrated fluid connection/drive train interface for an oral healthcare appliance, comprises: a handle including at least a housing; an actuator located within the handle and having a drive shaft extending from a distal end thereof, the actuator being configured to oscillate the drive shaft about a principal axis thereof by a given rotational movement amount; a fluid reservoir configured to store fluid for delivery, coupled to a pump for moving fluid from the reservoir through a fluid channel; and a fluid connection interface mechanically coupled with the drive shaft, and further configured to be coupled to a removable brushhead. The fluid connection interface comprises a fluid inlet coupling and a fluid outlet coupling, the fluid inlet coupling being coupled, via at least one fluid channel, to the fluid reservoir for enabling delivery of the fluid from the fluid reservoir to the fluid outlet coupling of the fluid connection interface. Responsive to the brushhead being removably coupled, the fluid outlet coupling of the fluid connection interface establishes at least one of a water tight or air tight sealing arrangement with a fluid interface receiver port of the brushhead. The drive shaft is configured for driving at least one of (i) the removable brushhead and (ii) the fluid connection interface through the rotational movement amount, while maintaining the at least one of the water tight seal or the air tight seal between the fluid outlet coupling of the fluid connection interface and the fluid interface receiver port of the removable brushhead. In one embodiment, the drive shaft is configured for driving both (i) the removable brushhead and (ii) the fluid connection interface through the rotational movement amount.

In one embodiment, the at least one of water tight and air tight sealing arrangement of the fluid connection interface is positioned at a center of rotation of the drive shaft. The rotational movement of the drive shaft can include any suitable rotational amount for a given oral healthcare appliance implementation. Furthermore, the fluid reservoir can be located within (i) internal to the handle (14) and/or (ii) external to the handle. Moreover, the fluid for delivery can comprise a liquid and/or a gas.

In another embodiment, the fluid connection interface is (i) coupled directly between the drive shaft and the removable brushhead or (ii) coupled to the removable brushhead in parallel with, but spaced off-center from, the drive shaft.

In yet another embodiment, the fluid outlet coupling of the fluid connection interface comprises one selected from the group consisting of (i) a parallel and in-line outlet coupling positioned at a center of rotation with the drive shaft and (ii) a parallel and offset outlet coupling positioned off-center from the drive shaft. In addition, the fluid connection interface can be coupled directly to the drive shaft, in parallel and in-line with the drive shaft, further wherein the fluid inlet coupling is positioned transverse to (i) the fluid outlet coupling and (ii) the drive shaft. Furthermore, the fluid outlet coupling of the fluid connection interface can establish the at least one of the water tight or air tight sealing arrangement with the fluid interface receiver port of the removable brushhead via a seal within the fluid interface receiver port, wherein the seal includes a duckbill valve extending from an end thereof.

In another embodiment, the fluid connection interface is offset from the drive shaft. In addition, the fluid outlet coupling of the fluid connection interface can establish the at least one of the water tight or air tight sealing arrangement with the fluid interface receiver port of the removable brushhead via a flexible rubber funnel shaped seal within the fluid interface receiver port, wherein the flexible rubber funnel shaped seal includes a non-return valve, for example a duckbill valve, extending from an end thereof.

In yet another embodiment, the fluid connection interface comprises a plastic, transition component part, wherein the plastic, transition component part further comprises a double walled sleeve which is configured to be fixedly attached to an end of the drive shaft, such that the double walled sleeve moves with the drive shaft, wherein the double walled sleeve further includes a fluid channel through the double walled sleeve, the fluid channel extending between the fluid inlet coupling and the fluid outlet coupling.

In a still further embodiment, the integrated fluid connection/drive train interface further comprises a brushhead mountable to the handle via the fluid connection interface mechanically coupled with the drive shaft, the brushhead having an elongated body with a principal axis, further having at least one fluid channel extending along the principal axis from (i) a fluid interface receiver port, at a proximal end of the elongated body, to (ii) a fluid outlet port, proximate a distal end of the elongated body, further proximate one or more bristles or set of bristles at or near the distal end.

In another embodiment, an oral healthcare appliance comprises the integrated water connection/drive train interface and a brushhead mountable to the handle via the fluid connection interface mechanically coupled with the drive shaft. A method of implementing an integrated fluid/connection drive train interface in an oral healthcare appliance is also contemplated.

Advantages and benefits will become apparent to those of ordinary skill in the art upon reading and understanding the following detailed description.

The embodiments of the present disclosure may take form in various components and arrangements of components, and in various steps and arrangements of steps. Accordingly, the drawings are for purposes of illustrating the various embodiments and are not to be construed as limiting the embodiments. In the drawing figures, like reference numerals refer to like elements. In addition, it is to be noted that the figures may not be drawn to scale.

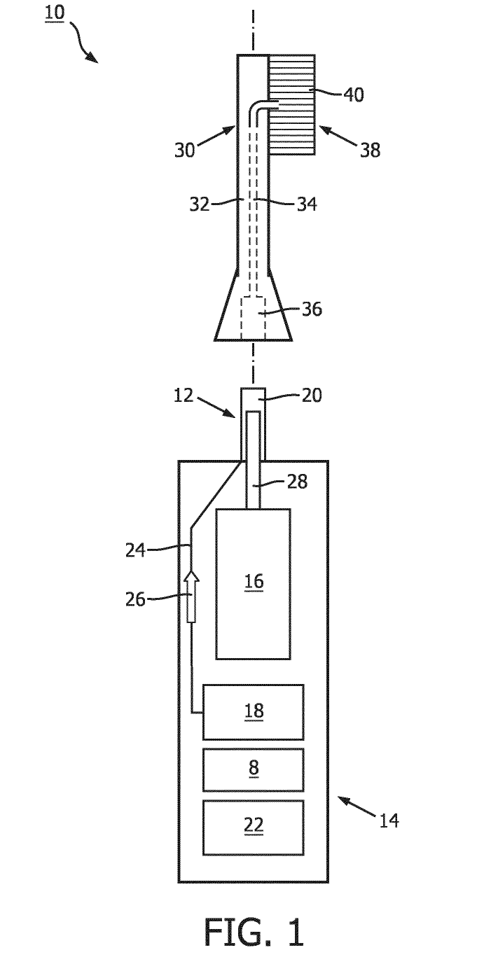

FIG. 1 is a schematic view of an oral healthcare appliance including an integrated fluid connection/drive train interface according to an embodiment of the present disclosure;

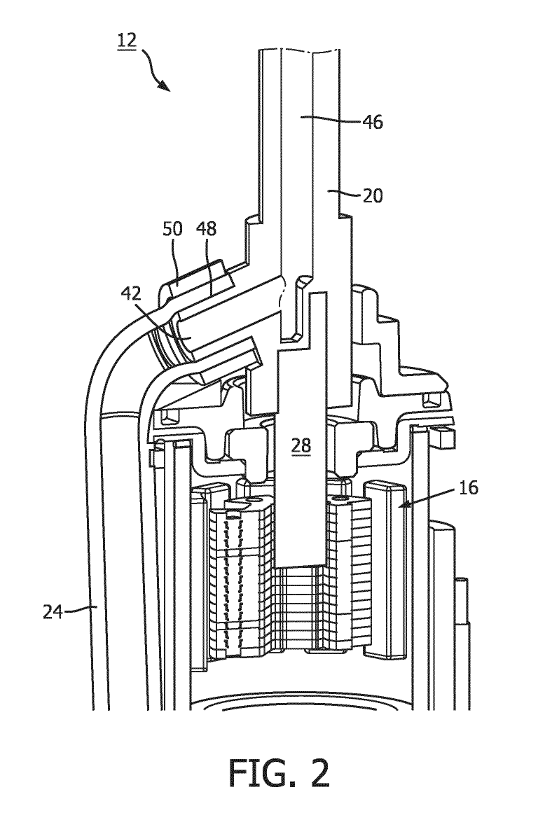

FIG. 2 is a schematic sectional view of an integrated fluid connection/drive train interface for an oral healthcare appliance according to one embodiment of the present disclosure;

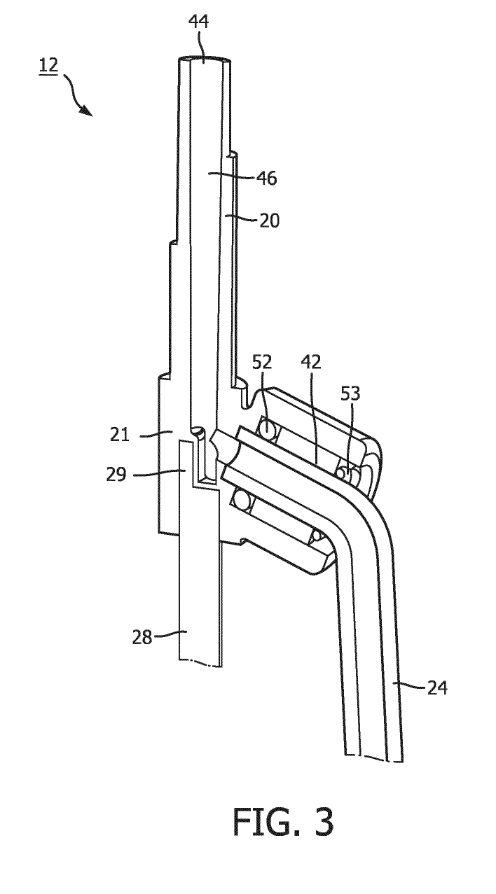

FIG. 3 is a schematic sectional view of an integrated fluid connection/drive train interface according to another embodiment of the present disclosure;

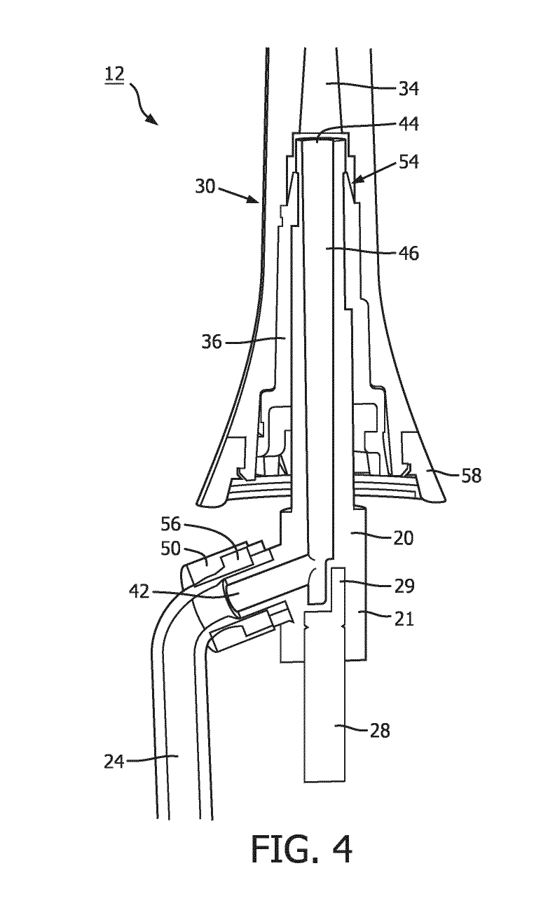

FIG. 4 is a schematic sectional view of an integrated fluid connection/drive train interface coupled with a brushhead for an oral healthcare appliance according to an embodiment of the present disclosure;

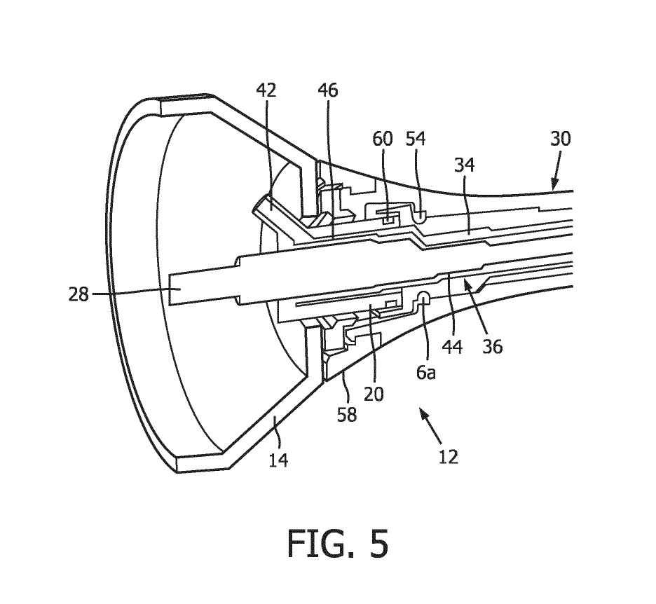

FIG. 5 is schematic sectional view illustrating a portion, of an integrated fluid connection/drive train interface according to another embodiment of the present disclosure;

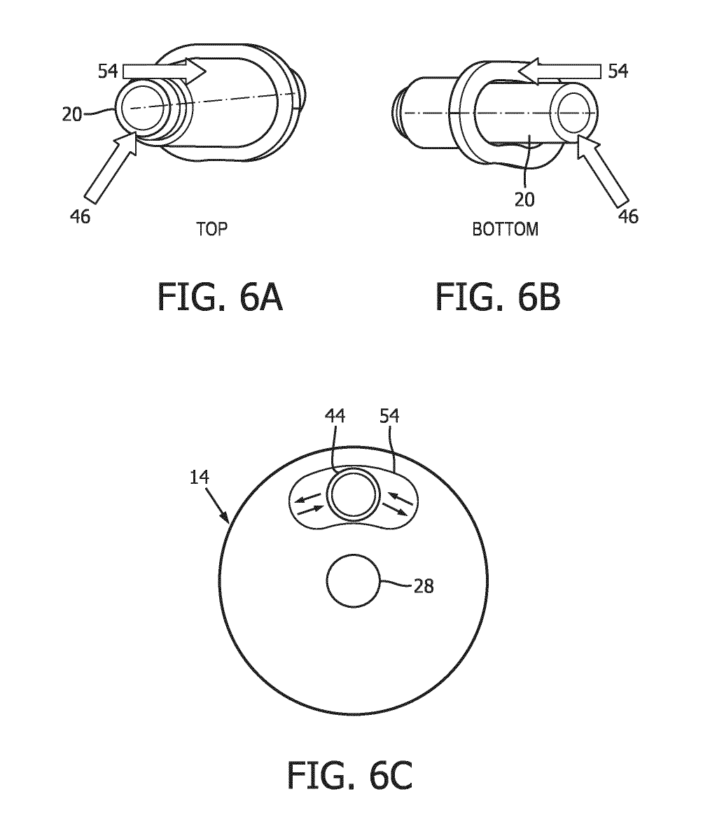

FIGS. 6A-6C show top and bottom perspective views, and a top view of a flexible seal of an integrated fluid connection/drive train interface according to another embodiment of the present disclosure; and

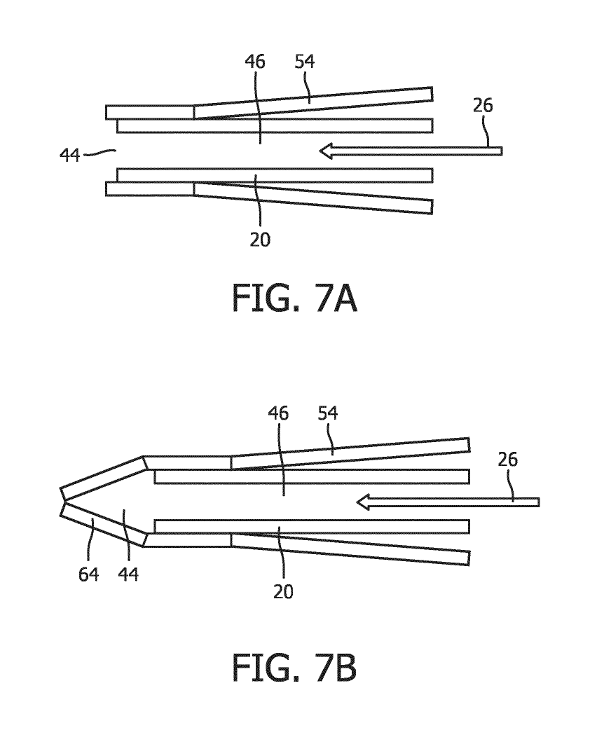

FIGS. 7A and 7B illustrate a seal, duckbill valve and fluid output coupling of the integrated fluid connection/drive train interface according to an embodiment of the present disclosure.

The embodiments of the present disclosure and the various features and advantageous details thereof are explained more fully with reference to the non-limiting examples that are described and/or illustrated in the drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the present disclosure. The examples used herein are intended merely to facilitate an understanding of ways in which the embodiments of the present may be practiced and to further enable those of skill in the art to practice the same. Accordingly, the examples herein should not be construed as limiting the scope of the embodiments of the present disclosure, which is defined solely by the appended claims and applicable law.

It is understood that the embodiments of the present disclosure are not limited to the particular methodology, protocols, devices, apparatus, materials, applications, etc., described herein, as these may vary. It is also to be understood that the terminology used herein is used for the purpose of describing particular embodiments only, and is not intended to be limiting in scope of the embodiments as claimed. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which the embodiments of the present disclosure belong. Preferred methods, devices, and materials are described, although any methods and materials similar or equivalent to those described herein can be used in the practice or testing of the embodiments.

With reference now to FIG. 1, there is shown a schematic diagram view of an oral healthcare appliance 10 including an integrated fluid connection/drive train interface 12 according to an embodiment of the present disclosure. In one embodiment, the oral healthcare appliance 10 comprises a power toothbrush with a liquid spray feature. The oral healthcare appliance 10 further comprises at least a handle 14, containing an actuator 16, a fluid reservoir 18, pump 8 and the fluid connection interface 20. In some arrangements of the oral healthcare appliance, the fluid reservoir and/or pump are located outside of and apart from the handle 14, or can be located both inside and outside the handle and be connected together. Further, pump 8 can be located inside the fluid reservoir 18, or be a separate component connected to the fluid reservoir. For illustration purposes, the fluid reservoir 18 and pump 8 are shown as separate components located inside the handle 14. At least one fluid channel 24 couples the fluid reservoir 18 to the fluid connection interface 20, for channeling at least one fluid in a direction indicated by fluid flow arrow 26. The fluid connection interface 20 may be mechanically coupled with the drive shaft 28 and is further configured to be coupled to a removable brushhead 30. The brushhead 30 is mountable to the handle 14 and is mechanically coupled with the drive shaft 28. While the term “brushhead” is used herein, it is intended to include any type of removable mechanism that can be coupled to the drift shaft of the oral healthcare appliance, and is not limited to removable mechanisms having a brush or bristles thereon.

The oral healthcare appliance 10 further includes device control electronics 22, wherein the device control electronics can comprise any suitable microprocessor, microcontroller, field programmable gate array (FPGA), integrated circuit, discrete analog or digital circuit components, and associated circuitry, display, switches, and/or power sources, whether implemented in hardware, software, and/or firmware, or any combination thereof, for performing various functions as discussed herein, further according to the requirements of a given oral healthcare appliance implementation and/or application.

With reference still to FIG. 1, actuator 16 is configured to oscillate a drive shaft 28 extending from a distal end thereof about a principal axis thereof by a given rotational movement amount. In one embodiment, the drive shaft 28 comprises a solid core, non-hollow drive shaft, as shown in FIG. 2.

Referring still to FIG. 1, the fluid reservoir 18 is configured to at least store a fluid for delivery. The fluid for delivery can comprises one or more of a liquid (e.g., water or other suitable aqueous solution) and a gas (e.g., air or other suitable gas), according to the requirements of a given oral healthcare appliance implementation and/or application.

The brushhead 30 includes an elongated body 32 with a principal axis, further having at least one fluid channel 34 extending along the principal axis from (i) a fluid interface receiver port 36, at a proximal end of the elongated body 32, to (ii) a fluid outlet port 38, at a distal end of the elongated body 32, and further may have one or more bristles or set of bristles (generally indicated by reference numeral 40) at or near the distal end of the elongated body 32.

Having now provided a brief description of the oral healthcare appliance with the integrated fluid connection/drive train interface illustrated in FIG. 1, a further brief background discussion will now be presented, to assist with a further understanding of the embodiments of the present disclosure. With such a power toothbrush, one solution for enabling a water supply through the brushhead-handle interface is to use a hollow drive shaft/axis that enables transmission of the liquid and/or air from handle to brushhead as well as transfer of the mechanical actuation forces to the brushhead, and easy attachment and/or detachment of brushhead to/from the handle. However, a hollow drive shaft/axis is not possible with all arrangements of actuators.

Alternatively, a water connection that is separate from the mechanical drive connection is possible. Such a separate connection would be out of center with the drive axis. Preferably, the integrated fluid connection/drive train interface, according to the embodiments of the present disclosure, enables an air and/or water connection at or near the center of rotation, either within the same sealed opening in the handle that holds the drive shaft, or in a separate sealed connection close by the center of rotation, thereby limiting undesirable friction and other forces that would impact the brushhead movement and result in higher power consumption.

Furthermore, a main challenge for the oral healthcare appliance is caused by the fact that the brushhead is a replaceable part. Therefore, the brushhead must be detachable, and as a result, the fluid path will be broken, i.e., disconnected and reconnected. Still further, aside from being detachable, the brushhead should also still be able to rotate or oscillate about its longitudinal axis, which means that the fluid interface will also be moving. The embodiments of the present disclosure provide methods of achieving such a suitable fluid interface.

According to one embodiment, as shown in FIG. 2, an integrated fluid connection/drive train interface 12 combines a solid-core drive shaft 28 with an adjacent fluid channel 24 in fluid connection interface 20. In one embodiment, the fluid connection interface 20 comprises a plastic material or any other suitable light weight, durable material. The drive shaft 28 can comprise, for example, metal or any other suitable high strength material. The fluid connection interface 20 is positioned at the top of/outside the handle 14, has liquid inlet and outlet connections, and forms an interface with a replaceable brushhead 30, as shown in FIG. 1. In this manner, the liquid supply to the brushhead 30 coincides with a center of rotation of the drive shaft 28 and actuator 16, such that undesirable limiting forces of connected tubing remain small (i.e., insignificant to a desired operation of the oral healthcare appliance).

Another advantage that the integrated fluid connection/drive train interface 12 provides is complicated, difficult shapes of the drive shaft are not needed, since any of a number of needed shapes can all be put into the fluid connection interface, which is typically made of plastic or other suitable light weight, durable, shapeable material. This will result in a lower manufacturing cost for the oral care device.

In the arrangement of the integrated fluid connection/drive train interface 12 shown in FIG. 2, the fluid connection interface 20 includes a fluid inlet coupling 42 and a fluid outlet coupling 44. The fluid inlet coupling 42 is coupled to the fluid reservoir 18 (FIG. 1), via at least one fluid channel 24. The fluid connection interface 20 is preferably configured into a desired shape and includes one or more seals to obtain a required mechanical connection with the brushhead 30 and to transfer water and/or air to the brushhead 30. Responsive to the brushhead 30 (FIG. 1) being removably coupled to the fluid connection interface 20, the fluid outlet coupling 44 of the fluid connection interface 20 establishes at least one of a water tight or air tight sealing arrangement with the fluid interface receiver port 36 of the removable brushhead 30, which will maintain the sealing arrangement during operation of the oral care device.

Fluid connection interface 20 is mechanically coupled, via any suitable mechanical coupling, to drive shaft 28 proximate the fluid inlet coupling 42. In one embodiment, fluid connection interface 20 is directly mechanically coupled to drive shaft 28, via complementary features or portions, 21 and 29, respectively of the fluid connection interface 20 and drive shaft 28. In one embodiment, feature 21 comprises a female part and feature 29 comprises a male part, wherein the two parts mechanically coupled together render the two parts to cooperate as a unitary part. Advantageously, the drive shaft 28 requires a minimum of finishing steps, since the “difficult” shapes as previously discussed herein, are now rendered in the fluid connection interface 20.

A fluid channel 46 couples the fluid inlet coupling 42 to the fluid outlet coupling 44. In one embodiment, the fluid inlet coupling 42 is positioned transverse to the fluid outlet coupling 44 and the drive shaft 28. In addition, the fluid outlet coupling 44 of the fluid connection interface 20 comprises a parallel and in-line outlet coupling that is substantially positioned at a center of rotation with the drive shaft 28. In addition, in one embodiment, the fluid channel 24 comprises a flexible tubing of a suitable inner-diameter adapted to fit over fluid inlet coupling 42. An outer surface of the fluid inlet coupling 42 may include at least one raised surface ring feature 48 configured to assist in establishing a water-tight seal between the tubing of fluid channel 24 and fluid inlet coupling 42. Furthermore, a retaining collar 50 may also be disposed overlying the tubing of fluid channel 24, to securely couple the fluid channel 24 to the fluid inlet coupling 42. As a result, a water-tight seal or connection for high pressure applications is advantageously provided.

Turning now to FIG. 3, there is shown a schematic sectional view of an integrated fluid connection/drive train interface 12 for an oral healthcare appliance according to another embodiment of the present disclosure. This embodiment is similar to that shown in FIG. 2, with the following differences. The fluid channel 24 comprises a flexible tubing of a suitable outer-diameter adapted to fit within the fluid inlet coupling 42. An inner surface of the fluid inlet coupling 42 includes at least one locking and/or sealing ring feature(s), 52 and 53, configured to assist in establishing a water-tight seal between the tubing of fluid channel 24 and fluid inlet coupling 42, further to securely mechanically couple the tubing of the fluid channel 24 to the fluid inlet coupling 42. As a result, a water-tight seal or connection for high pressure applications is advantageously provided.

With reference now to FIG. 4, there is shown a schematic sectional view of an integrated fluid connection/drive train interface 12 coupled with the brushhead 30 for an oral healthcare appliance according to another embodiment of the present disclosure. This arrangement is similar to the ones in FIGS. 2 and 3, with the following differences. The fluid channel 24 comprises a flexible tubing of a suitable inner-diameter adapted to fit over fluid inlet coupling 42. A retaining collar 50, with a compression locking ring 56, is disposed overlying the tubing of fluid channel 24, to securely mechanically couple the tubing of the fluid channel 24 to the fluid inlet coupling 42. Compression locking ring 56 compresses the tubing of fluid channel 24 and locks the tubing securely in place. In addition, a suitable sealing ring, element, and/or grommet 54, is provided inside the fluid interface receiver port 36 of replaceable brushhead 30.

The sealing ring, element, and/or grommet 54 comprises an inner-diameter configured for a sealing arrangement about the fluid outlet coupling 44 of the fluid connection interface 20. The water tight seal is thus formed in response to the brushhead 30 being attached to the handle 14, via the integrated fluid connection/drive train interface 12 being inserted within the fluid interface receiver port 36 of the brushhead 30. The water tight seal allows a fluid flow path to be formed between the fluid channel 46 of the fluid connection interface 12 and the fluid channel 34 of the brushhead 30. Brushhead 30 further includes a collar 58 disposed about the fluid interface receiver port 36 at a base thereof.

With reference now to FIG. 5, there is shown a sectional view of an integrated fluid connection/drive train interface 12 coupled with a brushhead 30, according to another embodiment of the present invention. In this embodiment, the fluid connection interface 20 comprises a double walled sleeve 60 which is configured to be fixedly attached to an end of the drive shaft 28, such that the sleeve fits around, is secured to, and moves with the drive shaft 28. The double walled sleeve 60 further includes a fluid channel 46 through the sleeve, the fluid channel 46 extending between the fluid inlet coupling 42 and the fluid outlet coupling 44. An inner portion of the double walled sleeve 60 overlies the distal end of the drive shaft 28. An outer portion of the double walled sleeve 60 extends only a partial length of the inner portion, which forms the fluid outlet coupling 44. An o-ring seal 62 is also provided proximate the fluid outlet coupling 44, for establishing a water tight seal with an inner circumference of the fluid interface receiver port 36 of the brushhead 30.

FIGS. 6A and 6B are top and bottom perspective views of a flexible seal 54 of an integrated fluid connection/drive train interface according to another embodiment of the present disclosure, when the. In one embodiment, fluid connection interface 20 is coupled to the removable brushhead, in line with, but off-center from, the drive shaft 28. In this embodiment, a flexible seal 54 is configured with room for oscillatory movement about the fluid outlet coupling 44, as can be seen in the top view, shown in FIG. 6C. In other words, the flexible sealing rubber is made to fit the fluid output coupling 44 on one end thereof, thus creating a water tight seal at the first end thereof, and made larger on the other end thereof, which is fixedly coupled to the brushhead, effectively allowing the water tight sealing arrangement between the brushhead and the rigid fluid connection interface 20 to move with respect to the brushhead 30. In another embodiment, a distal end of the flexible rubber funnel shaped seal 54 is provided with a duckbill valve 64, as shown in FIG. 7B, to be discussed further herein below

FIGS. 7A and 7B illustrate a seal 54 with a duckbill valve. FIG. 7B depicts the fluid connection interface 20 with fluid outlet coupling 44 and seal 54 of the brushhead with a duckbill value 64. The fluid outlet coupling 44 of the fluid connection interface 20 of the handle is attached to the brushhead via seal 54 which further includes a duckbill valve 64 extending from a distal end thereof, wherein the original shape of the seal 54 still renders the water tight seal with the fluid outlet coupling. The duckbill valve 64 provides a one-way flow of fluid in the flow direction 26, but prevents a flow in the reverse direction. In other words, the duckbill valve 64 advantageously prevents fluids from being drawn backwards into the appliance, thus reducing the risk of undesirable clogging and damage to the appliance.

According to yet another embodiment, a method of implementing an integrated fluid/connection drive train interface in an oral healthcare appliance, comprises: locating an actuator within a handle, the actuator having a drive shaft extending from a distal end thereof, the actuator being configured to oscillate the drive shaft about a principal axis thereof by a given rotational movement amount. The method further comprises configuring a fluid reservoir to at least one of (i) store and (ii) pump a fluid for delivery. The method further comprises mechanically coupling a fluid connection interface with the drive shaft, and further coupling a removable brushhead to the fluid connection interface. The fluid connection interface is further coupled to a fluid inlet coupling of the fluid reservoir via at least one fluid channel for enabling delivery of the fluid from the fluid reservoir to a fluid outlet coupling of the fluid connection interface. Responsive to removably coupling the brushhead, the fluid outlet coupling of the fluid connection interface establishes at least one of a water tight or air tight sealing arrangement with a fluid interface receiver port of the removable brushhead, wherein the drive shaft is configured for driving both (i) the removable brushhead and (ii) the fluid connection interface through the rotational movement amount, while maintaining the at least one of the water tight seal or the air tight seal between the fluid outlet coupling of the fluid connection interface and the fluid interface receiver port of the removable brushhead.

Accordingly, the measures/device features disclosed herein, to solve the identified problems and provide resulting advantages, include one or more of the following. An integrated fluid connection/drive train interface has been disclosed that comprises a connection for water and/or air transmission from an oral healthcare appliance handle to brushhead without negatively affecting the brushhead movement supplied via an actuator in the handle. The integrated fluid connection/drive train interface advantageously prevents expensive finishing steps of the central drive axis of the actuator and can be used in combination with different drive train actuators that have a central axis that rotates and/or oscillates over a certain angle or angular range. The embodiments of the present disclosure offer a better solution than provided via a hollow axis which requires specific water resistant material and is more expensive. The embodiments of the present disclosure advantageously comprise a coupling interface between the body of a device (with a rotating and/or oscillating drive shaft) and a detachable part, between which a fluid needs to be transported.

Although only a few exemplary embodiments have been described in detail herein above, those skilled in the art will readily appreciate that many modifications are possible in the exemplary embodiments without materially departing from the novel teachings and advantages of the embodiments of the present disclosure. For example, the embodiments of the present disclosure can be advantageously used in a variety of power toothbrush and/or oral irrigator applications which make use of other types of drive train movements, air supply and pressure communication with a brushhead, and other high pressure, or vacuum, type applications. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

In addition, any reference signs placed in parentheses in one or more claims shall not be construed as limiting the claims. The word “comprising” and “comprises,” and the like, does not exclude the presence of elements or steps other than those listed in any claim or the specification as a whole. The singular reference of an element does not exclude the plural references of such elements and vice-versa. One or more of the embodiments may be implemented by means of hardware comprising several distinct elements, and/or by means of a suitably programmed computer. In a device claim enumerating several means, several of these means may be embodied by one and the same item of hardware. The mere fact that certain measures are recited in mutually different dependent claims does not indicate that a combination of these measures cannot be used to an advantage.

1. An integrated fluid connection/drive train interface for an oral healthcare appliance, comprising:
a handle;
an actuator located within the handle and having a drive shaft extending from a distal end thereof, the actuator being configured to move the drive shaft about a principal axis thereof;
a fluid reservoir configured to store fluid for delivery, coupled to a pump (8) for moving fluid from the reservoir through a fluid channel; and
a fluid connection interface mechanically coupled with the drive shaft, and further configured to be coupled to a removable brushhead, the fluid connection interface having a fluid inlet coupling and a fluid outlet coupling, the fluid inlet coupling being coupled to at least one fluid channel for enabling delivery of the fluid from the fluid reservoir to the fluid outlet coupling of the fluid connection interface,
wherein responsive to the brushhead being removably coupled, the fluid outlet coupling of the fluid connection interface establishes at least one of a water tight or air tight sealing arrangement with a fluid interface receiver port of the removable brushhead, and
further wherein the drive shaft is configured for driving the removable brushhead and the fluid connection interface, while maintaining the at least one of the water tight seal or the air tight seal between the fluid outlet coupling of the fluid connection interface and the fluid interface receiver port of the removable brushhead.

2. The integrated fluid connection/drive train interface of claim 1, wherein the at least one of water tight and air tight sealing arrangement of the fluid connection interface is positioned at a center of rotation of the drive shaft.

3. The integrated fluid connection/drive train interface of claim 1, wherein the fluid reservoir is located within at least one selected from (i) internal to the handle and (ii) external to the handle.

4. The integrated fluid connection/drive train interface of claim 3, wherein the fluid reservoir and pump are located external to the handle.

5. The integrated fluid connection/drive train interface of claim 1, wherein the fluid for delivery comprises at least one of (i) a liquid and (ii) a gas.

6. The integrated fluid connection/drive train interface of claim 1, wherein the fluid connection interface is (i) coupled directly between the drive shaft and the removable brushhead or (ii) coupled to the removable brushhead in parallel with, but spaced off-center from, the drive shaft.

7. The integrated fluid connection/drive train interface of claim 1, wherein the fluid outlet coupling of the fluid connection interface comprises one selected from the group consisting of (i) a parallel and in-line outlet coupling positioned at a center of rotation with the drive shaft and (ii) a parallel and offset outlet coupling positioned off-center from the drive shaft.

8. The integrated fluid connection/drive train interface of claim 7, wherein the fluid connection interface is coupled directly to the drive shaft, in parallel and in-line with the drive shaft, further wherein the fluid inlet coupling is positioned transverse to (i) the fluid outlet coupling and (ii) the drive shaft.

9. The integrated fluid connection/drive train interface of claim 8, further wherein the fluid outlet coupling of the fluid connection interface establishes the at least one of the water tight or air tight sealing arrangement with the fluid interface receiver port of the removable brushhead via a seal within the fluid interface receiver port, wherein the seal includes a duckbill valve extending from an end thereof.

10. The integrated fluid connection/drive train interface of claim 7, wherein the fluid connection interface is coupled in parallel with and offset from the drive shaft.

11. The integrated fluid connection/drive train interface of claim 10, further wherein the fluid outlet coupling of the fluid connection interface establishes the at least one of the water tight or air tight sealing arrangement with the fluid interface receiver port of the removable brushhead via a flexible rubber funnel shaped seal within the fluid interface receiver port, wherein the flexible rubber funnel shaped seal includes a duckbill valve extending from an end thereof.

12. The integrated fluid connection/drive train interface of claim 1, wherein the fluid connection interface comprises a plastic, transition component part, wherein the plastic, transition component part further comprises a double walled sleeve which is configured to be fixedly attached to an end of the drive shaft, such that the double walled sleeve moves with the drive shaft, wherein the double walled sleeve further includes a fluid channel through the double walled sleeve, the fluid channel extending between the fluid inlet coupling and the fluid outlet coupling.

13. The integrated fluid connection/drive train interface of claim 1, further comprising:
a brushhead mountable to the handle via the fluid connection interface mechanically coupled with the drive shaft, the brushhead having an elongated body with a principal axis, further having at least one fluid channel extending along the principal axis from (i) a fluid interface receiver port, at a proximal end of the elongated body, to (ii) a fluid outlet port, proximate a distal end of the elongated body, further proximate one or more bristles (40) or set of bristles at or near the distal end.

14. An oral healthcare appliance, comprising:
the integrated water connection/drive train interface of claim 1; and
a brushhead mountable to the handle via the fluid connection interface mechanically coupled with the drive shaft, the brushhead having an elongated body with a principal axis, further having at least one fluid channel extending along the principal axis from (i) a fluid interface receiver port, at a proximal end of the elongated body, to (ii) a fluid outlet port, proximate a distal end of the elongated body, further proximate one or more bristles or set of bristles at or near the distal end.

15. A method of implementing an integrated fluid/connection drive train interface in an oral healthcare appliance, comprising:
locating an actuator within a handle, the actuator having a drive shaft extending from a distal end thereof, the actuator being configured to oscillate the drive shaft about a principal axis thereof by a given rotational movement amount;
configuring a fluid reservoir to at least one of (i) store and (ii) pump a fluid for delivery; and
mechanically coupling a fluid connection interface with the drive shaft, and further coupling a removable brushhead to the fluid connection interface, the fluid connection interface further being coupled to a fluid inlet coupling of the fluid reservoir via at least one fluid channel for enabling delivery of the fluid from the fluid reservoir to a fluid outlet coupling of the fluid connection interface,
wherein responsive to removably coupling the brushhead, the fluid outlet coupling of the fluid connection interface establishes at least one of a water tight or air tight sealing arrangement with a fluid interface receiver port of the removable brushhead, and
further wherein the drive shaft is configured for driving both (i) the removable brushhead and (ii) the fluid connection interface through the rotational movement amount, while maintaining the at least one of the water tight seal or the air tight seal between the fluid outlet coupling of the fluid connection interface and the fluid interface receiver port of the removable brushhead.
